(19) United States
(12) Patent Application Publication
(10) Pub. No.: US 2013/0340320 A1
(43) Pub. Date: Dec. 26, 2013

(54) METHOD AMD DEVICE FOR ATTRACTING AND BAITING TERMITES

(71) Applicant: ION LESLIE STAUNTON, QUEENSLAND (AU)

(72) Inventor: ION LESLIE STAUNTON, QUEENSLAND (AU)

(21) Appl. No.: 13/922,477

(22) Filed: Jun. 20, 2013

(30) Foreign Application Priority Data
Jun. 20, 2012 (AU) 2012-902586
Mar. 13, 2013 (AU) 2013-900867

(51) Int. Cl. A01M 1/20

(52) U.S. Cl. CPC A01M 1/2011
USPC 43/131; 43/132.1

(57) ABSTRACT

A kit of termite detector units may be used by a homeowner or a business owner in a commercial environment to form an effective protective barrier or boundary around the property with the “X”s illustrating typical placement positions detector units. The units are placed in locations where termites might be anticipated and typically the units can be placed at two to five meter spacings, although in some cases they may be spaced even further apart. This is because these units are on a large concrete area and they are placed at construction joints since the termites are more likely to travel along the joint as the line of least resistance they will be intercepted by the detector. Bait units may then be applied to infested detectors in an effort to kill the termite colony.

THIS INVENTION relates to termite detection and baiting and in particular but not limited to a method for laying out termite detectors, checking for the presence of termites inside the detectors and subsequent application of bait to the detectors once termites have been detected.

Termites become a problem when they infest a building. It is best to prevent infestation. Preventative measure include physical and chemical barriers around a property. Physical barriers include in ground barriers such as mesh screens. Chemical barriers include insecticides injected into the ground around building. Termite traps are also used. It is well known that termites are attracted to wood. Wood has been used as an attractant in termite traps. The termites are lead to the wood by carbon dioxide produced by the oxidation of the wood. Termites return to their nest and more termites are then able to follow the path of pheromones produced by the termites to the source of food. The trap then becomes infested by foraging termites. The traps are inspected from time to time and if termites are present the trap is inoculated with a toxic agent designed to be carried back to the nest in the hope of eliminating the entire colony. A typical toxin would be a growth regulator to stop nymphs growing.

The most common form of detector is a monitoring station planted in the ground or in concrete with an exposed part serving to enable inspection of the interior of the detector. The main problem is that current monitoring stations are set into the ground or through concrete so termites can gain access. Most homeowners do not have tools to easily install them in ground with stones, plant roots or solid rock barely covered in soil nor do they have the required concrete drilling tools. Monitors should ideally surround timber structures and most homes have concrete paths, concrete driveways or pavers abutting walls, sometimes extending out to the boundaries, meaning up to half the perimeter of the house cannot be “guarded” unless the paths are drilled. This is not a DIY solution. The enticement to get termites into the monitor is not just the timber attractive to termites (E. regnans) but the termites need to know it is there. Moist timber surfaces develop fungal growth and the degradation releases CO2. Foraging termites are highly perceptive in detecting CO2 and move “upstream” to find the source. Occasionally wetted timber also secrets stains and other micro nutrients which foraging termite scouts detect. Enticing termites out of the soil into timber is a simple matter. It happens because it is there, termites find it because they continually seek out new food sources. However a monitor is an aggregation device that must also double as a feeding station to be effective. Disturbing feeding termites can often result in the termites vacating a monitor and sealing off access to the monitor by closing off the access tunnels closer to the nest from the device. Opening a monitor to check for the arrival of termites can cause disturbance enough to negate the effort taken to get termites into the station at the time it is appropriate to begin adding the bait.

It will be appreciated that there are many variations on this basic theme or placement of monitors secured in the ground or even on timber walls and they are all, to varying degrees, workable, but are generally inconvenient for the public to use. Therefore they are mainly supplied and maintained by professional pest control companies. It would be desirable to provide a system that is significantly easier to use than the current arrangements so that this method may be more widely accepted and used by the public. Applicant is of the view that the present inventor has been the first to recognise the inherent problems in these systems being made acceptable to the public. The public tend to be somewhat anxious about the possible existence of termites in their neighbourhood and applicant has found are lacking in confidence to readily adopt a preventative measure that to date has largely been a professional concern. Further in devising applicant's solution to this basic problem the inventor has encountered fresh difficulties and solved those as well, but those fresh difficulties could not have arisen without the first step of recognising the problem associated with the public fear and perception of the difficulties in termite control.

With this in mind the present invention provides a method for deployment of termite detectors, simply by placing the detectors on the ground around a site to be protected from termites whereby the relationship between the detectors is such as to provide a hedge of protection about the site. The detectors are effectively sentinels that draw termites to the detectors. Once termites are found bait is then delivered to any detectors where termites have been found. Bait may be delivered directly into an infested unit by lifting the lid and putting it directly into the unit although this is not preferred. Alternatively bait may be made available to or delivered to termites in a unit without opening the unit through a small opening. This may be by injecting a bait composition through one or more capped openings in the unit. These can then be closed up again.

Preferably, the detectors are put together so they are simple ready to go units rather than having to be made up by the user or for any ground preparation being made. Similarly, while the bait may be delivered in many ways, again rather than make it complex, a simple bait delivery unit, already to go, is provided to make the system easier to use. In this way detectors may be simply scattered around a site or set in a particular pattern. For example, for efficacy, the closer the spacing the better the protection but usually detectors may be placed more than 2 m apart but usually, no more than about 5 m apart. The detectors typically comprise a packaged kit of detector units, each unit comprising a container having a base, a side wall and a top and defining within the container, a termite occupation zone. The detectors are equipped with attractant and being adapted to provide an environment for the undisturbed infestation by feeding termites entering the container through openings in the container. The openings are typically in the base and sides of the container for entry of termites from underneath or entry of termites from the side.

The container preferably removably holds termite attractant, typically wooden slats, the slats slid into the container, and there being provided an observation opening for visual detection of the occupation of the unit by termites.

The kit also includes at least one bait delivery unit, although the bait delivery units may be sold separately of the detectors. The bait delivery unit typically comprises a bait container holding bait, each termite detector may have bait delivery unit docking arrangement comprising at least a passage means enabling termites to travel between the detector and the bait delivery unit when a bait delivery unit is docked with a detector unit. It is therefore preferable that each bait delivery unit has a matching dock to automatically align the passage means between the units. The bait delivery unit passage means, may align with the observation opening, but there could be one or more other openings for this purpose. The observation opening need not be the same as the bait delivery opening. It should also be noted that “bait delivery” as herein used does not mean that bait is delivered into the detector unit, all that is required is that bait be accessible to the termites in the detector unit. The bait delivery unit may just sit in place on the detector and may simply have some locating means such as flange.

Preferably, the dock, the passage means and the observation opening are adapted to cooperate in such a way as to minimise disturbance of the termites when the bait delivery unit is being docked. Preferably, there is provided in the top of the detector unit, a dock in the form of locating means, typically an arrangement of projections which automatically locate the bait delivery unit. The projections may be a group of flanges inside which the bait delivery unit sits in operative alignment. The bait delivery unit need not have any coupling or particular docking features itself and may simply sit in position or it may have positive coupling means as in a clip-in-position feature so that it is positively held.

The bait deliver unit may be of any suitable shape of configuration for stable mounting on the detector. Preferably, the bait delivery unit is in the form of a cup-like vessel having a top, bottom and side wall and bait mix inside and being normally closed with a wide topped opening and a top cap to closing the top opening a bottom opening in the bottom, the opening having a cap and also being normally closed. In use, the top cap is taken off the top and water added to the bait mix, the contents is mixed with the water and then closed, the top cap is secured, the unit is inverted, the bottom opening cap removed and the unit inverted again and quickly placed in position on the dock of an infested detector. As will be described below termites are detected when they close off an observation opening with a plug of regurgitated digested wood mix, in this case momentarily before placing the bait unit in place the plug is manually displaced and the bait unit is put in place. In another embodiment the bait unit comprises a bait applicator for delivery of bait to pests by the pests entering the applicator and feeding on the bait, the applicator comprising a bag containing bait and being adapted to lie substantially flat against a surface near to pests but being flexible enough to be moulded to the surface if required, the bag having a surface fastening means and a normally closed opening into the bag, the fastening means enabling the applicator to be applied to the surface with the opening positioned for entry of pests into the bag to feed on the bait when the bag has been fastened to the surface.

In a preferred form the observation opening is a purposely designed hole so that DIYers (“do it yourselfers”) could determine with a passing glance whether termites had arrived in the detector/monitor. If the opening is too large, termites are deterred from making the effort to close it. A small hole would be quickly and easily closed but the DIYer could have difficulty noticing whether it was still open or blocked. The reason termites block openings is to enclose their working galleries to maintain their preferred atmosphere: warm and humid.

The opening is the point of atmospheric change between what the termites prefer and they can control in relation to the outside ambient conditions which are mostly less humid and either hotter or colder. Termite workers and soldiers are eyeless and although it cannot be claimed they don't perceive a difference between light and dark, they do sense the change of atmospheric conditions. Since the termites are highly receptive to the climatic changes it is important to get a balance between the size of the opening they will block, the size to make visual inspection easy and to minimise disturbance of the internal environment once termites are detected. Blocking an opening does three things for the benefit of the termites: it excludes predatory ants, it allows a significant amount of control of the internal atmosphere and with minimum effort, it extends the range of their galleries by enclosing additional surface area on which to begin feeding.

As mentioned above bait is applied to the detector/monitor and is accessible through the observation opening. There are insecticidal preparations and in the years ahead there will be more. They can be in many forms, dusts, foams, gels, liquids, pastes, maybe even gases and any effective substance can be employed which will effectively be a contaminant to the termites environment. The monitor once attacked by termites becomes a controlled environment in which termites have aggregated in large number for the purpose of feeding to transfer this food back to the main nest. With minimal to nil disturbance any such bait contaminant can be introduced to the monitor through the opening and it is inadvertently transferred back to the main nest.

These agents would not need to be added via an external bait delivery unit. If such an agent is introduced into the monitor through the observation opening, once this operation is completed, the hole can be quickly and simply closed by the application of some adhesive tape or a plug, Alternatively the lid can be opened, the two centre slats could be withdrawn and a large amount of paste bait mix added in the space.

In order that the present invention may be more readily understood and be put into practical effect reference will now be made to the accompanying drawings and wherein: —

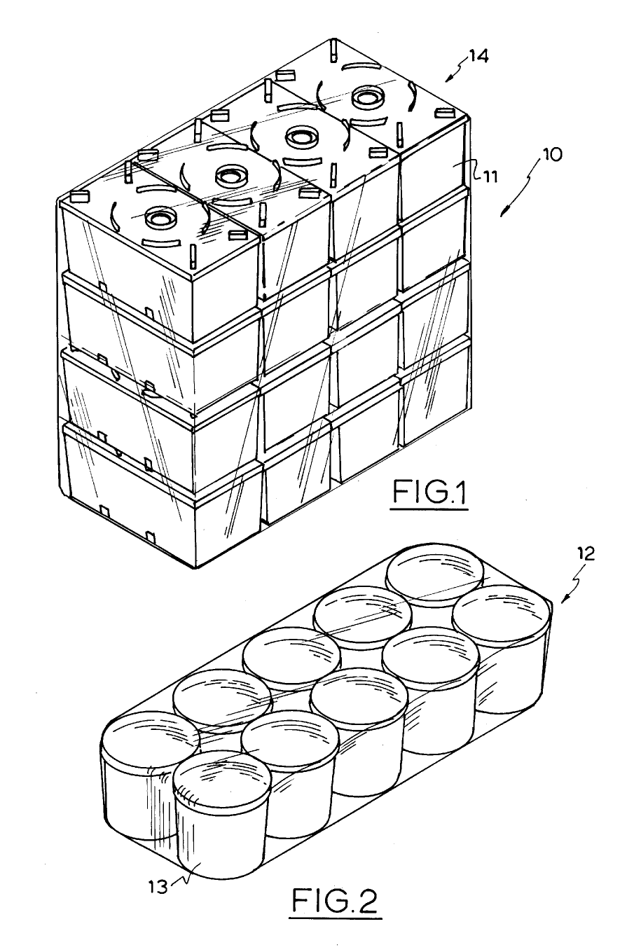

FIGS. 1 and 2 illustrate a packaged kit of detectors and bait units according to the present invention;

FIGS. 3-7 are respective orthographic views of a typical detector with FIG. 6 representing sections through VI in FIG. 5;

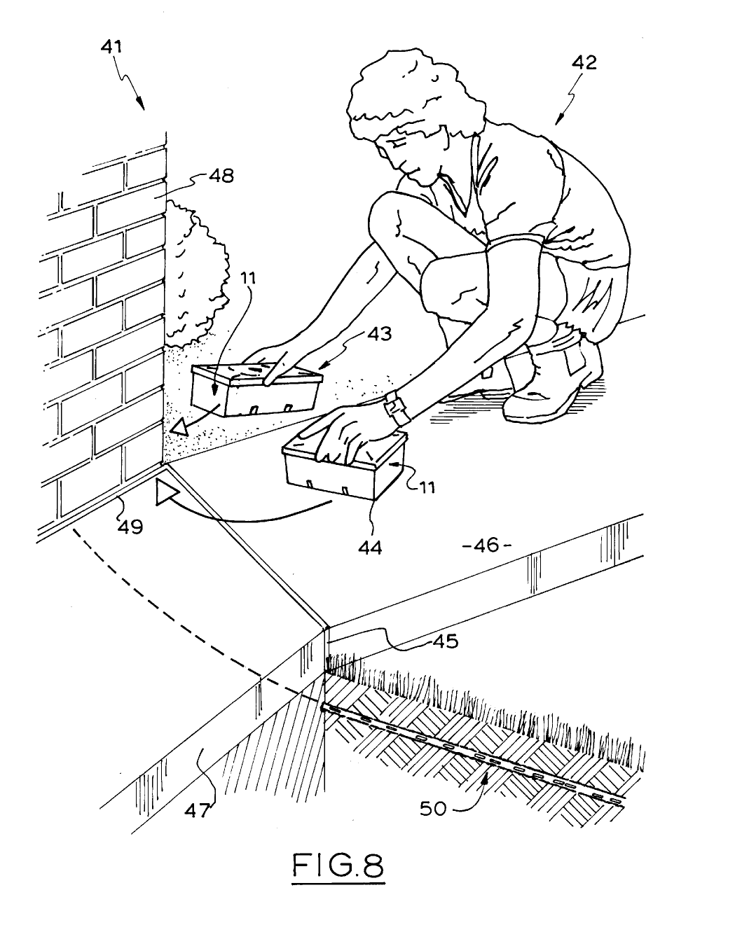

FIG. 8 is a drawing illustrating the simplicity of detector deployment;

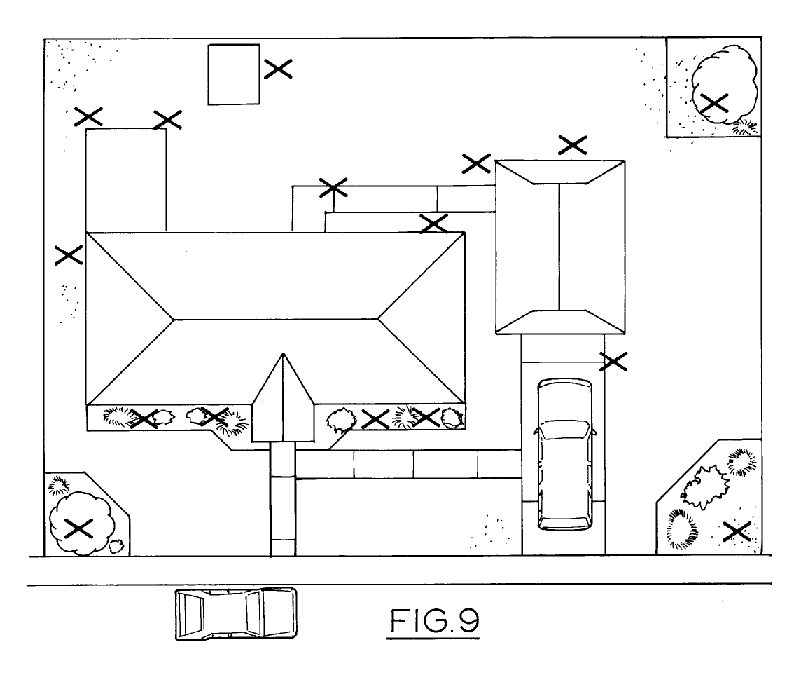

FIG. 9 is a schematic drawing showing a typical deployment for a protective hedge or a sentinel barrier around a domestic dwelling;

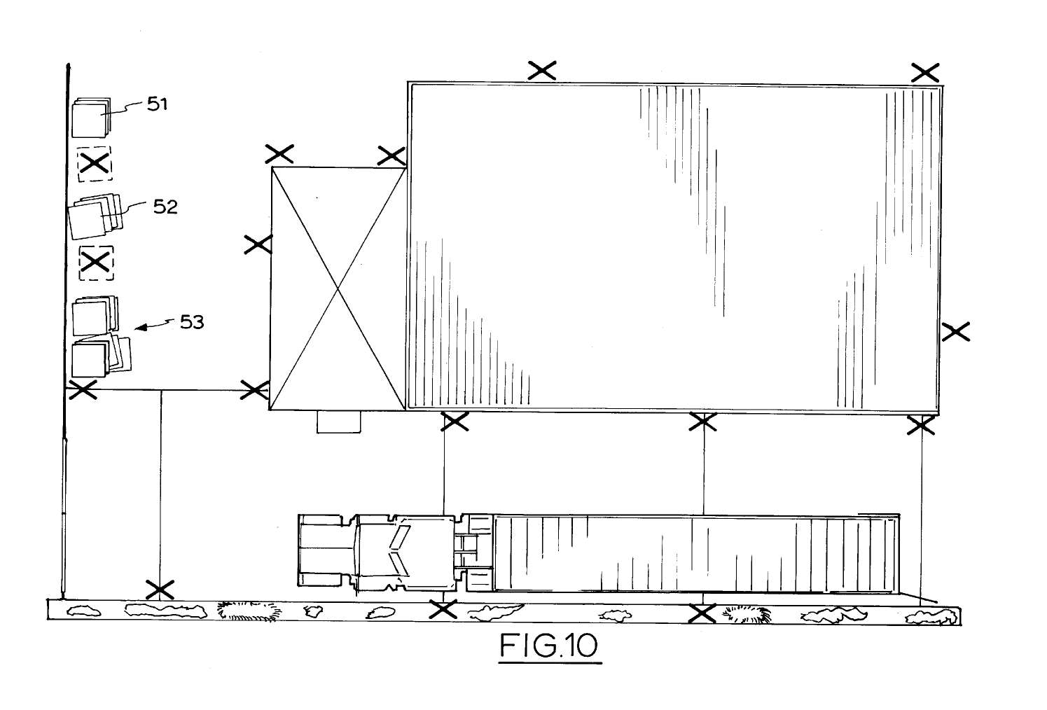

FIG. 10 is a drawing similar to FIG. 9 except in this case it is for a factory or warehouse as an example of application in a commercial or industrial environment;

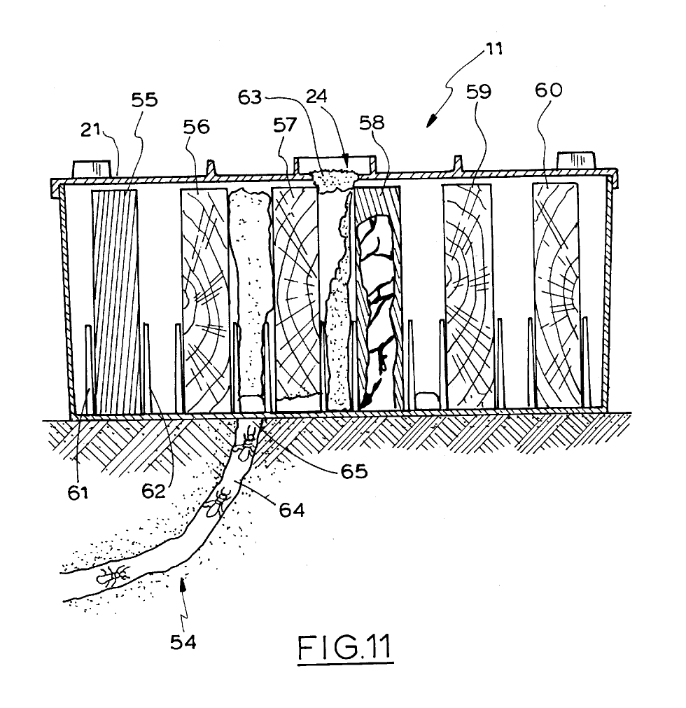

FIG. 11 is a longitudinal section through a detector unit where termites have occupied the unit;

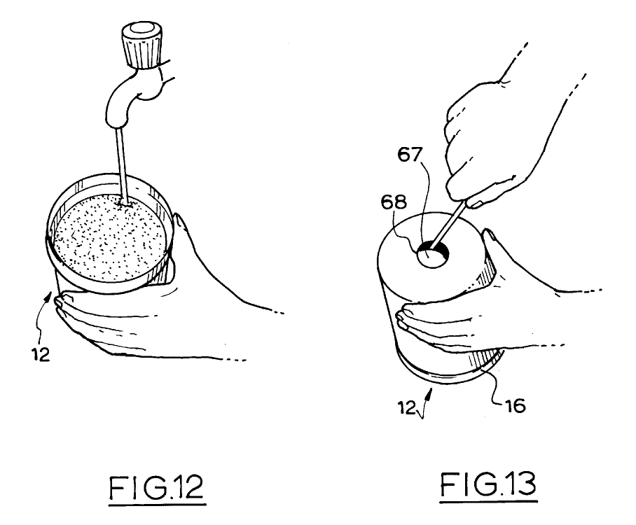

FIGS. 12 and 13 illustrate the stages in preparation of a bait delivery unit for application to the detector unit of FIG. 11;

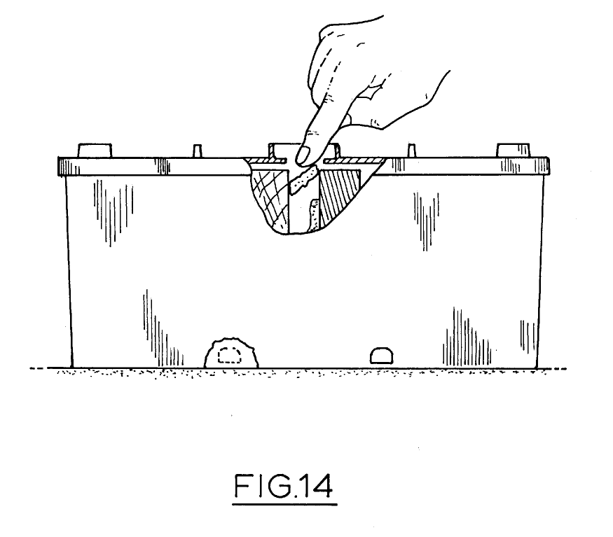

FIG. 14 illustrates a step whereby the unit of FIG. 11 is prepared for docking of the bait delivery unit by punching out a termite created plug in an observation opening;

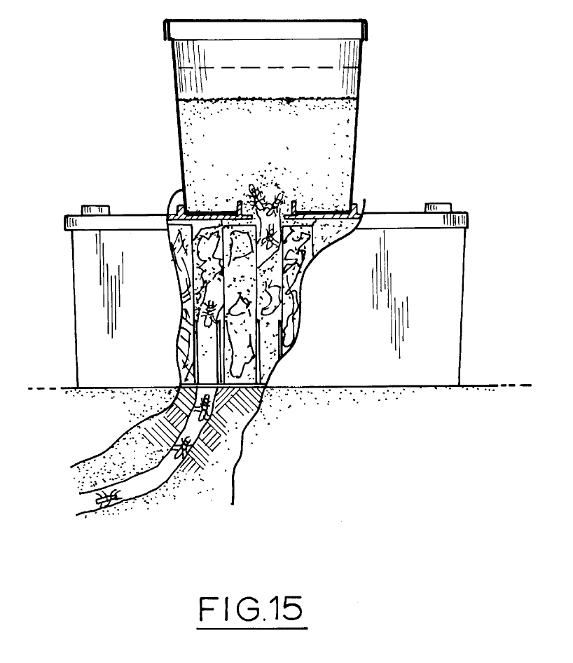

FIG. 15 is a cutaway view showing the docked delivery unit with termites foraging on the bait;

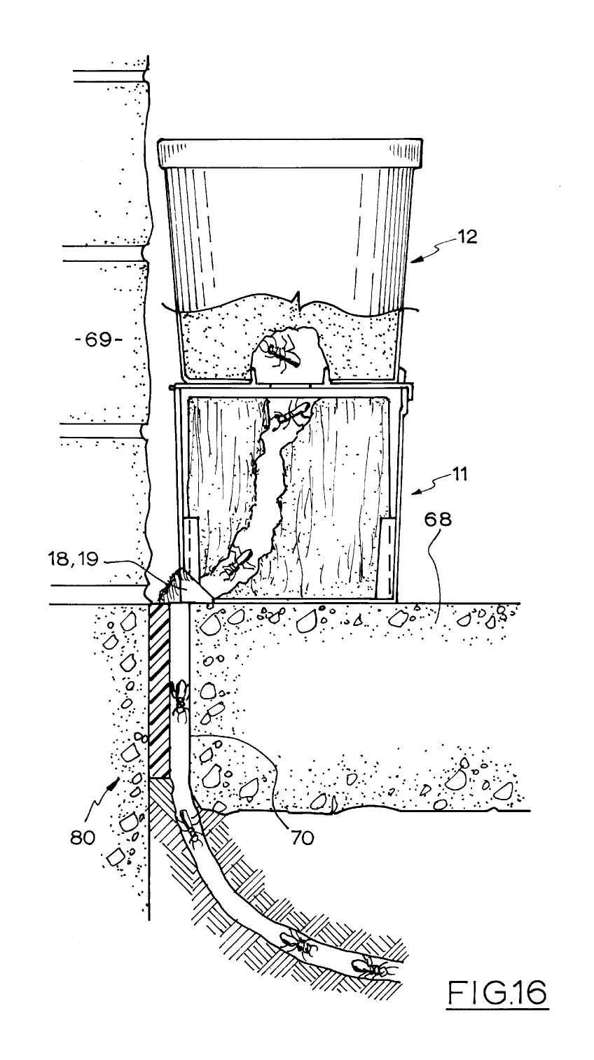

FIG. 16 is an end view of a baited unit near to a construction joint in concrete;

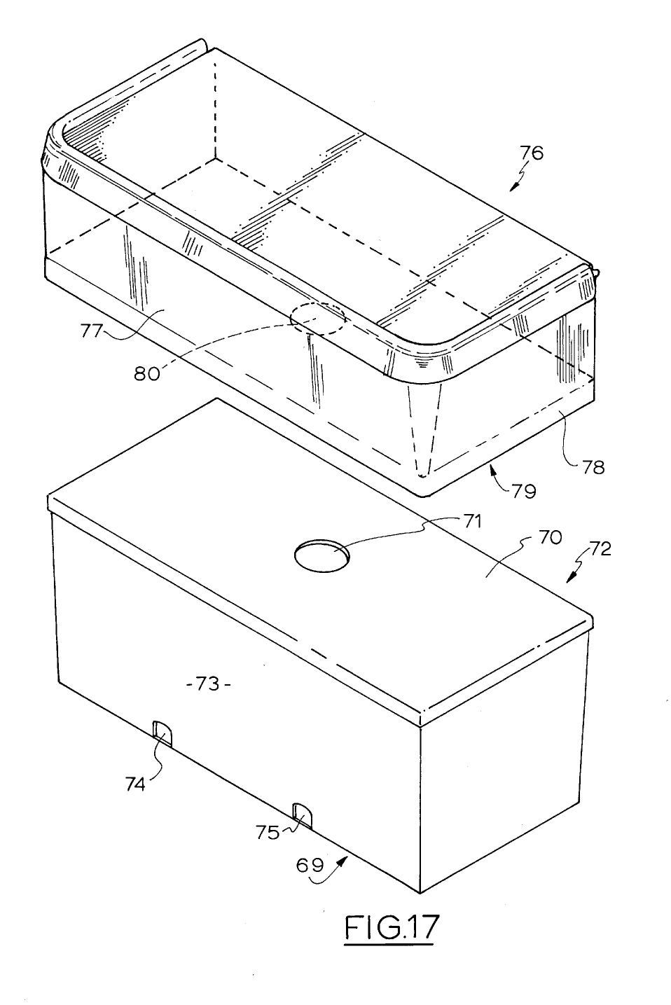

FIG. 17 is a drawing showing an alternative embodiment with a rectangular bait delivery unit;

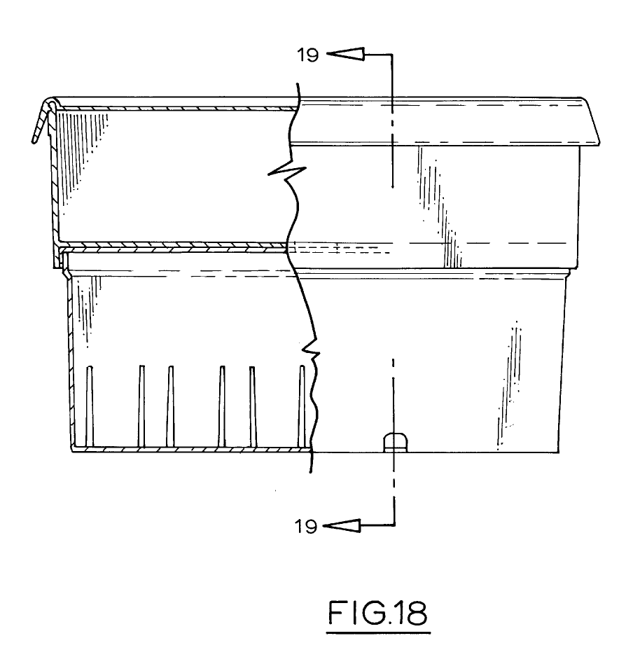

FIG. 18 is a cutaway view showing the detector unit and bait delivery unit of FIG. 17 operatively one on top of the other;

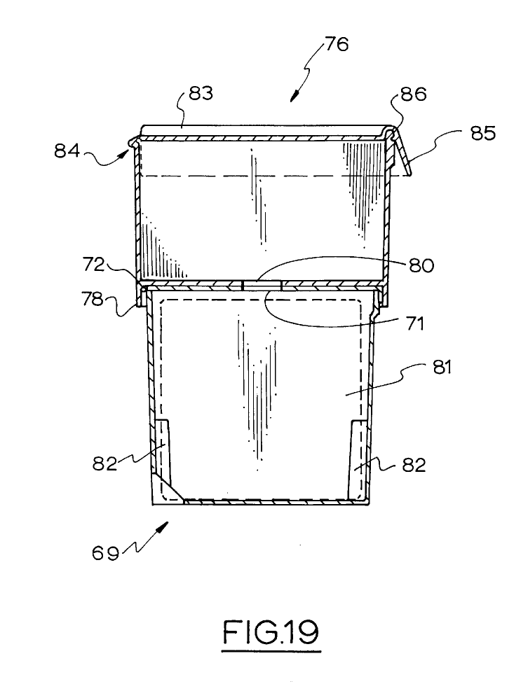

FIG. 19 is a section through 19-19 of FIG. 18;

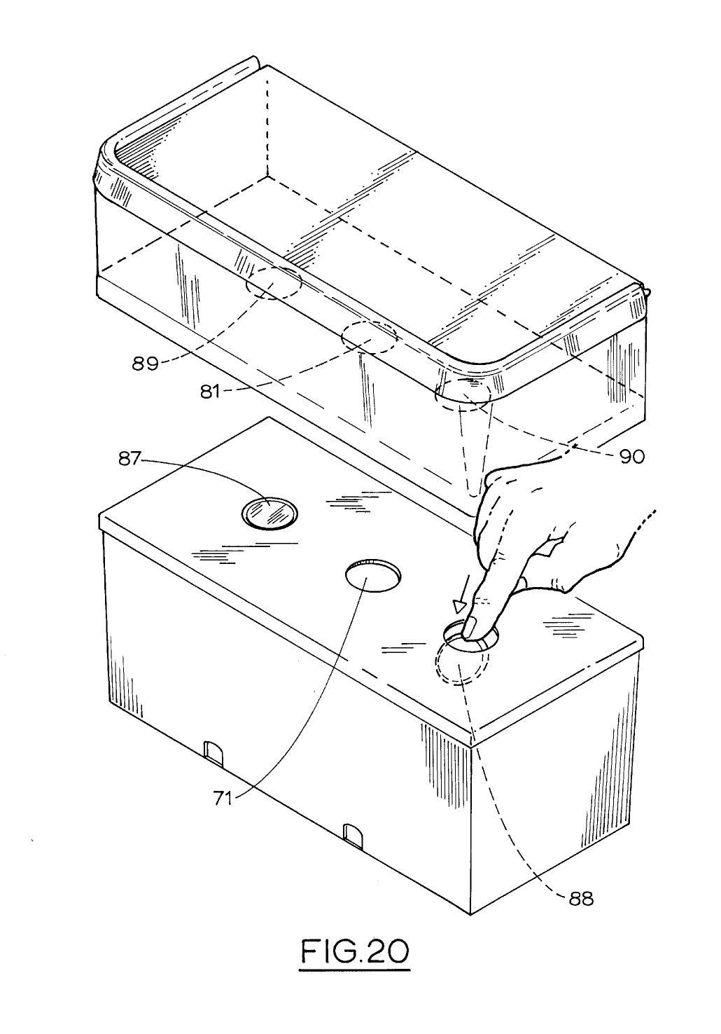

FIG. 20 shows another embodiment similar to FIG. 17 but with extra termite passages between the detector and bait delivery units; and

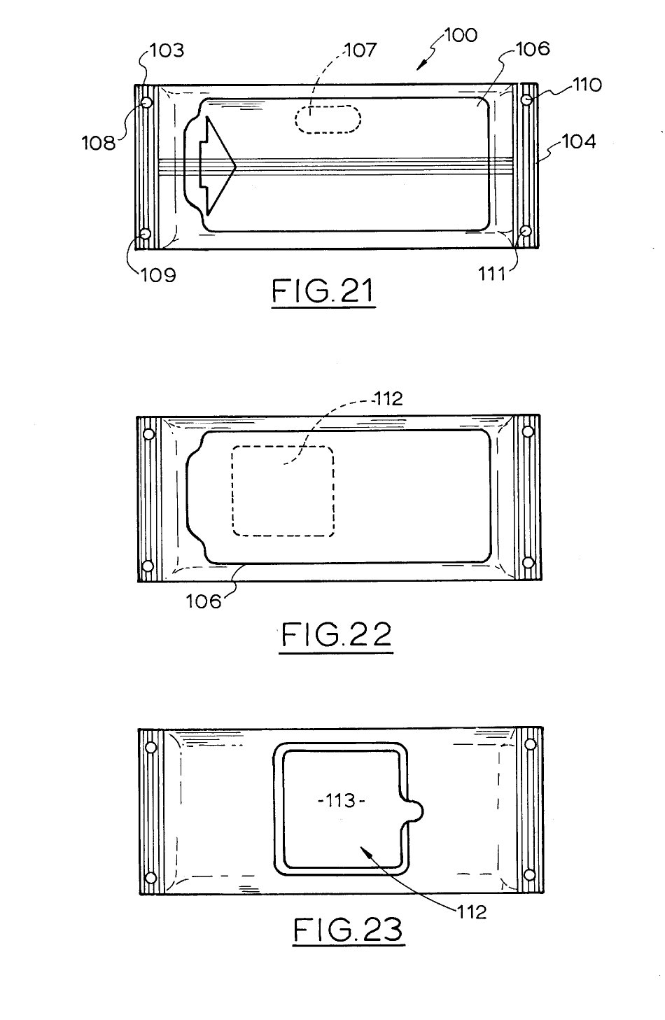

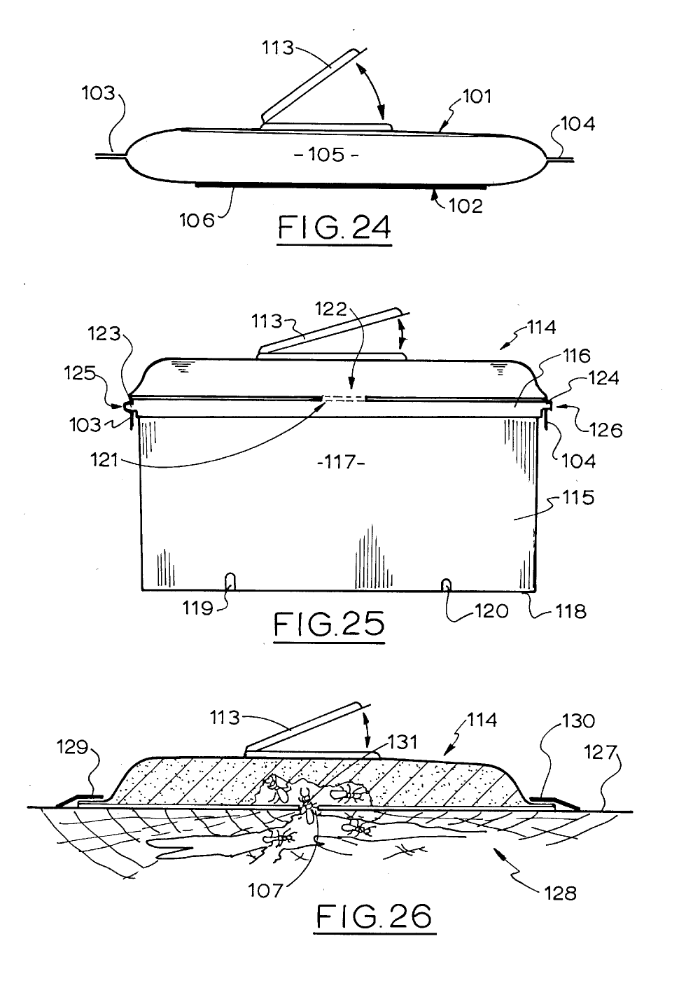

FIGS. 21-26 are drawing illustrating a flexible bag type bait unit.

Referring to the drawings and initially to FIGS. 1 and 2 there is illustrated in FIG. 1 a package 10 containing sixteen detectors or monitoring units 11 and in FIG. 2 is a package 12 containing ten bait delivery units 13. The bait delivery units and/or the detector units are adapted for docking, typically the bait units with each of the units 11 using the docking section 14 of the detector units visible through the packaging in the top set of four units shown in FIG. 1. This will be explained in greater detail below.

FIGS. 1 and 2 serve to illustrate the simplicity of the present invention insofar as termite monitoring and baiting can be accomplished by a householder who simply may go to the supermarket or to the garden department of the local hardware store and buy the prepackaged kit 10. The householder would see the kit and its very basic instructions as a totally new approach to termite control. Also at the same time, if so choosing, buy the prepackaged bait units 12 so that the bait units can be applied to the detector units 11 as soon as termites are detected.

Alternatively, it will be appreciated from FIGS. 1 and 2 that the householder only need buy the detectors and then at a later time when termites are detected go and buy the bait units. Not only does this packaging form alleviate the supposed complexity of pest management, in the case of termites, but it indicates that the homeowner can do it themselves and this form of product relieves any anxiety associated with monitoring and control of termites. Economically, it also provides a simple alternative to the requirement for professional pest control services and the non-professional may feel confident in applying the present invention.

While “Do it Yourself” (DIY) is itself commonplace, particularly in home renovation and other areas where the DIYer is in clear control of the work to be carried out, it must be remembered that the field of termite control is a highly developed field and the associated problems of DIY in this field have to date been unrecognised due largely to the inability of DIYer's to see what is going on “underground” and understand termite behaviour. They tend to rely on the professionals.

The present invention provides an advance in an otherwise highly developed field and although in hindsight the advance of simply placing detectors around a site, the combination of the detectors working together to protect the whole site, may seem very simple applicant considers recognising the need as being the primary inventive step.

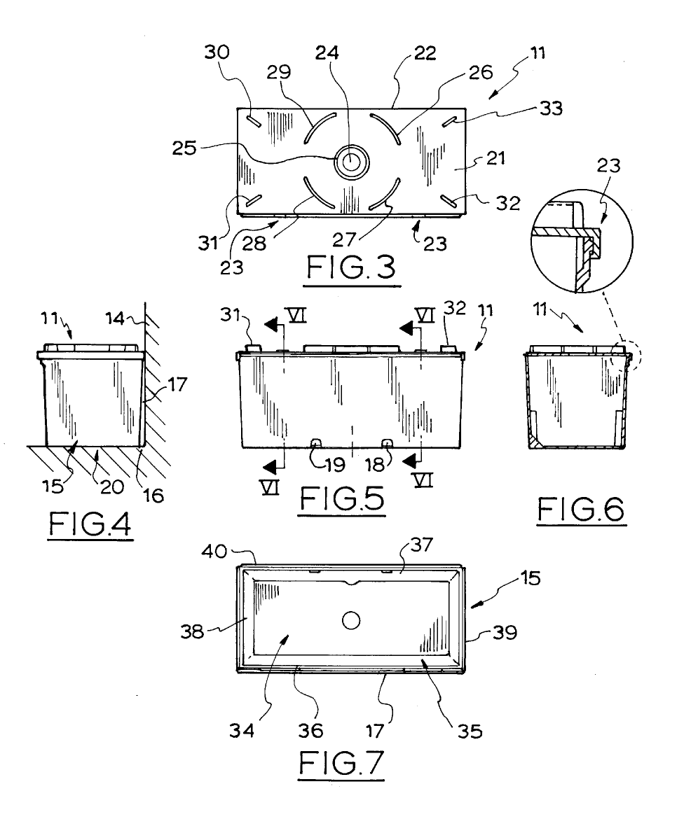

Before dealing with the method of implementation of the units 11 and 13 illustrated in FIGS. 1 and 2 it is pertinent to examine in greater detail the structural characteristics of the detector units 11 and in this regard reference will now be made to FIGS. 3 to 7. FIG. 3 is a plan view, FIG. 4 an end view, illustrating one important feature of the unit, FIG. 5 is a side view, FIG. 6 is an opposite end view and FIG. 7 is an underside view.

Referring firstly to FIG. 4, the unit 11 is about a hand span in width or near to a standard housing brick size overall so that it can be easily handled. It is hollow plastics and light weight. It is slightly wider at the top than at the bottom so that it has a sidewall taper. Applicant found during design applicant considered square and rectangular shapes but that simple placement of these, being a useful aspect of the invention, could result in termite entry into a detector being inadvertently blocked, by too close a placement to a wall. So to avoid this problem if it is placed against a wall 14, or some other similar situation, the base 15 of the unit will be spaced, with a small gap 16 at the base from the wall due to the taper, so that termites that might be making their way up adjacent the wall 14 will have sufficient space to enter the detector through holes 18 and 19 in the side wall 17.

This could of course be accomplished by other means for example having an undercut in the side wall at the base and so on. Side entry holes are shown more clearly in FIGS. 5 at 18 and 19. For example, these will come into play, particularly in the situation where the unit 11 is located on a concrete path 20 and there is joint adjacent a wall by the path.

The unit 11 has a lid 21 hinged along one edge 22 which adds strength to the side wall on which it is hinged. The lid 21 is adapted to be secured closed. Typically, it has two spaced clip means and these engage corresponding catches on the opposite edge at 23, these are spaced at about one third and two thirds spacing so that the lid may be clipped and secured closed. These are shown in the inset to FIG. 6. Any suitable clip means may be employed, it being the case that the lid can be secured closed to ensure that there is a completely closed environment for termites to work and operate within the detector, during the detecting and monitoring stage.

As can also be seen in FIGS. 3 and 5 the lid 21 has a central circular opening 24, this is surrounded by an upstanding circular flange 25. Concentric with the circular flange 25 are circular sections of locating flanges 26, 27, 28 and 29. As will be described below along with flange 25 these serve as a dock to locate a bait unit 13 on top of the detector unit 11 when it is desirable to bait a detector. Outside of these locating flanges 26, 27, 28 and 29 are additional projections or lugs 30, 31, 32 and 33. These are positioned to serve as spacers for stacking in the package 10. They are of the same height as the circular flange 25 and the lugs 26 to 29 so that the units can stack as illustrated in FIG. 1 for packaging and transport purposes.

In relation to FIG. 7 the detector unit being rectangular is designed to be readily infested and to this end the underside 15 has an almost a full size rectangular opening 34. This opening is surrounded by a peripheral inward projecting horizontal flange 35. The peripheral flange 35 has long flange sections 36 and 37 and side flanges 38 and 39. The long flanges 36 and 37 are used to block the timber slats that have been inserted from the top when the lid 21 is open. The slats bridge across from side to side. The underside is to fit flush on the ground so that there is no space between the unit and the ground.

The present invention has as one of most important features the simplicity of application of the invention so that non professional persons may feel confident in detecting and treating termites and this aspect can be seen in the next three drawings. There is illustrated in FIG. 8 part of a property 41 with a householder 42 holding two detectors 11, detector 43 in one hand and a detector 44 in the other hand and working out where they should be put. Perhaps the unit 43 could be put on the ground while the unit 44 could be put adjacent the joint 45 in the path 46. unknown to the householder a termite attack is pending at 50 and these termites will be attracted to units placed on the paths 46 or 47 and adjacent the joints 45 and 47.

Referring now to FIGS. 9 and 10 these are schematic drawings illustrating how a homeowner in FIG. 9 or a business owner in a commercial environment in FIG. 10 may form an effective protective barrier or boundary around the property with the “X”s illustrating typical placement positions detector units 11. The units are placed in locations where termites might be anticipated and typically the units can be placed at two to five metre spacings, although in some cases they may be spaced even further apart as shown in the two rear wall units in the FIG. 10 embodiment. This is because these units are on a large concrete area and they are placed at construction joints since the termites are more likely to travel along the joint as the line of least resistance. they will be intercepted by the detector. The FIG. 9 embodiment is a suburban home while the FIG. 10 embodiment is a small warehouse, timber pallets are shown at 51, 52 and 53 adjacent the boundary of the property.

Once the units 11 have been placed, detection is substantially as illustrated in FIG. 11 where as shown termites 54 have burrowed under the unit 11, entered the unit 11 from underneath and began to digest the timber slats 55, 56, 57, 58, 59 and 60 which are located in the unit between the slat guides two of which are shown at 61 and 62. The slat guides are in the side walls and the slats 55 to 60 are prevented from sliding through and out through the bottom by the peripheral flange as illustrated in FIGS. 3 through to 7. Very soon after entering the detector, the termites block off the opening 24, as shown with a plug of digestive material at 63. The opening 24 is in the middle of the lid 21 and the presence of the plug 63 this serves as a visual indication of the presence of termites in the detector. In this case the termites have entered through a passage 64 which opens into the interior of the unit 11 through an opening at 65.

Once the plug 63 is in place the termites then begin to work digesting the timber slats and carrying food back to the nest to feed the nymphs, soldiers and the queen and it is by this means that the nest may be inoculated with a toxic agent. The present invention may use any suitable toxic agent but preferably uses an insect growth regulator such as Chlorfluazuron. The growth regulator is usually included in some kind of carrier and mixed with the carrier and this could be applied directly into the interior of the unit 11 simply by lifting the lid 21 and then closing the lid. Applicant considered this option which is usually the method used by professional pest companies and while it would work applicant considered it problematic for the non-professional who might not appreciate the problem of disturbance.

Thus in a preferred form applicant has devised a method to apply the bait to the termites within the detector with a minimum of disturbance. Too much disturbance might see the termites close off the opening 65 preventing access to the nest. Once they do this, the few termites in the detector will die but the termites from the nest will no longer operate within the detector 11 and move on and the bait will be of no effect.

As illustrated in FIG. 2 the present invention includes bait units and these bait units come prepackaged with a powder to which water is added. The powder includes the growth regulator, typically in the quantity of 1 gram per kilogram, 90 grams of this mixture is included in each container in terms of the present invention. To this 330 millilitres of water is added and this is illustrated in FIG. 12. In order to add the water a cap 66 is removed. Once the water is added the mixture is in the form of a paste of a consistency of mashed potato or porridge, the lid 66 is replaced, the unit turned over and a cap 67 removed to expose an opening 68. The bait unit is ready to go and may be quickly upturned and docked with the detector unit in a matter of seconds.

Once the visual presence of termites has been detected by reason of the plug 63 being in place, the mixture has been prepared, the bait unit may then be quickly and easily applied with the minimum of disturbance to termites within the container 11. This is done simply by popping the plug 63, with a tool or simply a finger, as shown in FIG. 14. The bait unit 12 is located directly over the hole 24 with it becoming automatically aligned with opening 68 into the bait unit utilising the docking flanges as previously described.

There need not be hardly any disturbance of the termites apart from pushing the plug out and quickly placing the bait unit in position. The termites within the container should not detect any change in environment other than ultimately the availability of a new food source which, relatively speaking, is easier for them to ingest than the timber slats. Thus, preferentially, the termites will start to enter the cup and digest the bait as illustrated in FIG. 15. Thus in terms of FIG. 15 the situation is illustrated where there will be some partial digestion of the timber slats and then preferential digestion of the bait held within the bait unit 12. Thus the termites will return to the nest and carry the growth regulator back to the nest for ultimate destruction of the nest.

Circumstances illustrated in FIGS. 11 and 15 show direct entry through the main opening 34 in the bottom of the detector unit whereas FIG. 16 illustrates a situation where a detector unit 11 has been placed over a concrete path 68 adjacent to wall 69. In this latter case termites have made their way up adjacent the edge 70 of the concrete through a joint at 80 and have entered the detector unit through one of the openings 18 or 19 rather than through the opening 34 which is blocked by the concrete path.

It will be appreciated that the units 11 and 12 may be of any shape but it is best that they be suited to transport and ease of handling by the end user. It may be that the units 12 could be rectangular as will be described below in relation to FIGS. 17-20 but applicant has chosen cylindrical in these embodiments to ease mixing so this is a trade off since they are relatively small. There may be more openings in the sides, the attractant could be any suitable attractant and the timber slats could be positioned in any way, the present case being to enable reuse by replacing the slats but the detector units could be completely disposable.

Referring now to FIGS. 17-19 there is illustrated a detector unit 69 (wooden slats shown in phantom in FIG. 19) which is basically the same as the units 11 except its lid 70 is completely flat with a central observation opening 71. The lid 70 is hinged along edge 72. The front face 73 has two termite entrance openings 74 and 75. In this embodiment the bait delivery unit 76 is rectangular to form with the detector 69 a contiguous block or brick like assembly with the detector 69. The bait delivery unit 76 has a side wall 77, a peripheral flange 78 and a base 79 that fits over the detection unit so that the base 79 of the bait delivery unit 76 overlaps the lid 70 in contact with it, while hole 71 in the detector lid 70 is aligned with hole 80 (shown in phantom) in the base 79 of bait delivery unit 76. This is more clearly shown in FIG. 19 with the timber detector slats shown at 81 in phantom in their operative positions between locating flanges 82. The flange 78 serves as the docking arrangement so that the holes 71 and 80 are properly aligned.

The flange 78 may afford a simple sit on top fit of the bait unit against the lid of the detector or the relative dimensions may afford a resistance fit for a more secure or positive coupling or the lid and flange may have small ribs and grooves or other co-operating parts for positive connection.

The bait delivery unit has a lid 83 hinged along edge 84. The lid has a lift flange 85 and a clip closure 86. In use the opening 80 is normally closed by a removable cap and is baited and works the same way as for the previous embodiment in relation to FIGS. 1-16. As described in the previous embodiments once termites are detected, water is added to the bait in bait unit 76 in exactly the same way and then the bait delivery unit 76 is placed over the detector 69 as shown in FIG. 19 thus forming a passage for termites to travel between the units.

FIG. 20 in all material aspects is the same as FIGS. 17-19 embodiments and (like numeral illustrated like features) but with extra holes for termite transit between the units. The central hole 71 remains an observation opening but to allow the passage of termites extra holes may be made using pushouts 87 and 88 to form holes. The bait unit in this case has matching holes with removable caps. It will be appreciated in this embodiment the hole 71, which has been covered by termites as an observation opening, need not be disturbed and the other holes used for termite transit between the units Also if the invention is to be applied in this way the bait delivery unit need not have hole 81.

Referring to FIGS. 21-24 there is illustrated a bait applicator 100 which may be used as a bait unit for a detector, the applicator comprises two sheets of opaque and/or reflective plastic material 101,102 heat welded with a weld seam at each end making a margin 103, 104 at each end. This margin may be used for taping or stapling of the applicator in place. The applicator is preloaded with a bait matrix 105 but is not overloaded so as to make it too full so that it is not able to be bent or moulded should this be required.

Of course it will be appreciated that the size, flexibility and malleability may vary depending upon the application. Thus the bag may come in different sizes and different capacities. For example, if the applicator is designed for application to a detector as shown in FIG. 25 then it would be made to match and therefore it could be filled to capacity. A bag when filled may typically be about 2-10 cm thick, 5-10 cm wide and 15-20 cm long. If it was to be used in a corner of a room or around a post it may be larger and carry half the amount of bait matrix. Of course, if added flexibility is required the user may simply manipulate an amount of bait to one end or may even remove some of the matrix to get the desired fit in a tricky corner.

In the FIG. 21 embodiment there is a peel off sheet 106 which when removed exposes a layer of adhesive and a hole 107 (shown in phantom). The applicator may then be stuck on a surface once pests such as termites have been detected and the termites may travel through the hole 107 to get to the bait matrix and feed on it. In the case of termites, the amount of disturbance applying a baiting regime can reduce effectiveness so the tabs 103 and 104 may be used to further secure the ends. Holes 108-111 may be used for screws or the width of the tabs may suit a masking or packing tape.

In some cases it may be desirable to inspect the contents of the applicator and in the illustrated embodiment an inspection opening 112 with a hatch door 113 is provided. This hatch door may also be used to introduce water to activate the bait matrix or put more bait into the applicator or just to have a look. The bait matrix may be pre-wetted and the pack vacuum sealed so in these circumstances it may be desirable to make the access opening by cutting it onsite so the opening 107 would be cut rather than pre-formed. The hatch would not be present they could be of course be present if the integrity of the seal could be maintained. The adhesive patch could be employed regardless of the presence of a hole 107.

It will be appreciated that these added features are purely optional and that all that is required to implement the method is a pre-packed bag in which a hole may be made and the bag may be secured in any manner. In the FIG. 21 embodiment the inspection hatch 113 is not used.

Referring to FIG. 25 the embodiment 114 of FIGS. 22-24 is applied to a monitor 115. The monitor has a lid 116 while the body 117 contains attractant (not shown) usually timber slats and there are openings in the base 118 and in the side walls at 119, 120. The monitor may be of the type that fits on the ground or it may be buried.

When termites are present in the monitor/detector the termites block off the observation opening 121 in the lid 116 and this is the tell-tale sign that it is time to bait.

Thus the bait applicator 114 has an opening 122 matched to the opening 121 when an adhesive patch cover sheet 106 is removed so that the bait unit is secured in place with holes aligned. In the embodiment of FIG. 5 the tabs 103, 104 fit into slots 123, 124 in the lid 116 or the lid may include four projections with flared ends, one on each of the corners which simply “pop” through holes 108-111. Two of these projections 125, 126 are shown as another option in FIG. 25 to slots for the tabs.

FIG. 26 shows application of an applicator to an already infested wall where termites have been feeding at 128 and again optionally the adhesive patch may be used or tape as shown at 129 and 130. In this case a hole would be drilled or punched through the wall 127 at 131 to correspond to a hole made in the applicator or aligned with the pre-made hole.

In some cases the hole that is formed in the factory may not best suit the position of the applicator so another hole may be simply cut at the time and the applicator fitted accordingly.

Whilst the above has been given by way of illustrative example many variations and modifications will be apparent to those skilled in the art without departing from the broad ambit and scope of the invention as set out in the appended claims.

1. Termite detectors comprising a packaged kit of detector units, each unit comprising a container having a base, a side wall and a top and defining within the container, a termite occupation zone, the detectors being equipped with attractant and being adapted to provide an environment for the undisturbed infestation by feeding termites entering the container through openings in the container, the openings being in the base and sides of the container for entry of termites from underneath or entry of termites from the side and there being provided an observation opening for visual detection of the occupation of the unit by termites.

2. The kit according to claim 1 including at least one bait delivery unit, the bait delivery unit comprises a bait container holding bait, each termite detector having an opening alignable with a corresponding opening in the bait delivery unit.

3. The kit according to claim 2 wherein each detector unit and each bait unit have a docking arrangement comprising at least a passage means that enabling termites to travel between the detector and the bait delivery unit when a bait delivery unit is docked with a detector unit.

4. The kit according to claim 4 wherein each bait delivery unit has a matching dock to automatically align the passage means between the units, the bait delivery unit passage means, being aligned with the observation opening.

5. The kit according to claim 1 wherein there is provided in the top of the detector unit, a dock in the form of locating means, being an arrangement of projections which automatically locate the bait delivery unit.

6. The kit according to claim 1 wherein the projections are group of flanges inside which the bait delivery unit sits in operative alignment.

7. The kit according to claim 1 wherein the bait delivery unit is in the form of a cup-like vessel having a top, bottom and side wall and bait mix inside and being normally closed with a wide topped opening and a top cap to closing the top opening, a bottom opening in the bottom, the opening having a cap and also being normally closed, in use, the top cap is taken off the top and water added to the bait mix, the contents is mixed with the water and then closed, the top cap is secured, the unit is inverted, the bottom opening cap removed and the unit inverted again and quickly placed in position on the dock of an infested detector.

8. The kit according to claim 1 wherein the bait delivery unit comprises a bait applicator for delivery of bait to pests by the pests entering the applicator and feeding on the bait, the applicator comprising a bag containing bait and being adapted to lie substantially flat against a detector, the bag being adapted to be fastened to the detector with an opening positioned for entry of pests into the bag to feed on the bait when the bag has been fastened to the detector.

9. The kit according to claim 1 wherein the detector is rectangular box and the bait delivery unit is a rectangular box matched to the detector and adapted to sit on top of the detector with a passage between the two for movement of termites.

10. A termite detector as defined in claim 1.

11. A termite detector bait delivery unit as defined in claim 1.

12. The kit according to claim 2 wherein there is provided in the top of the detector unit, a dock in the form of locating means, being an arrangement of projections which automatically locate the bait delivery unit.

13. The kit according to claim 3 wherein there is provided in the top of the detector unit, a dock in the form of locating means, being an arrangement of projections which automatically locate the bait delivery unit.

14. The kit according to claim 4 wherein there is provided in the top of the detector unit, a dock in the form of locating means, being an arrangement of projections which automatically locate the bait delivery unit.

15. The kit according to claim 2 wherein the projections are group of flanges inside which the bait delivery unit sits in operative alignment.

16. The kit according to claim 3 wherein the projections are group of flanges inside which the bait delivery unit sits in operative alignment.

17. The kit according to claim 4 wherein the projections are group of flanges inside which the bait delivery unit sits in operative alignment.

18. The kit according to claim 5 wherein the projections are group of flanges inside which the bait delivery unit sits in operative alignment.

19. The kit according to claim 2 wherein the bait delivery unit is in the form of a cup-like vessel having a top, bottom and side wall and bait mix inside and being normally closed with a wide topped opening and a top cap to closing the top opening, a bottom opening in the bottom, the opening having a cap and also being normally closed, in use, the top cap is taken off the top and water added to the bait mix, the contents is mixed with the water and then closed, the top cap is secured, the unit is inverted, the bottom opening cap removed and the unit inverted again and quickly placed in position on the dock of an infested detector.

20. The kit according to claim 3 wherein the bait delivery unit is in the form of a cup-like vessel having a top, bottom and side wall and bait mix inside and being normally closed with a wide topped opening and a top cap to closing the top opening, a bottom opening in the bottom, the opening having a cap and also being normally closed, in use, the top cap is taken off the top and water added to the bait mix, the contents is mixed with the water and then closed, the top cap is secured, the unit is inverted, the bottom opening cap removed and the unit inverted again and quickly placed in position on the dock of an infested detector.
